(19) United States
(12) Patent Application Publication
(10) Pub. No.: US 2002/0103615 A1
(43) Pub. Date: Aug. 1, 2002

(54) Dynamic technique for fitting pressure-suits to individuals

(75) Inventors: Menachem Levanoni, Yorktown Heights, NY (US); Jerome M. Kurtzberg, Yorktown Heights, NY (US)

Correspondence Address: Stephen C. Kaufman, Intellectual Property Law Dept., IBM Corporation, P.O. Box 218, Yorktown Heights, NY, 10598, US

(73) Assignee: International Business Machines Corporation, Armonk, NY (US)

(21) Appl. No.: 09/771,804

(22) Filed: Jan. 29, 2001

(51) Int. Cl. G01L 7/00

(52) U.S. Cl. 702/139

(57) ABSTRACT

A method utilizing continual sensor-based data to design and adjust pressure-suits to fit an individual. The invention capabilities include cognizance of the dynamic workings of the body in a changing real environment. For example, the stresses and accelerations experienced by the body during normal flight operations, may be taken into design account, to thereby provide an optimal balance between support and comfort.

### BACKGROUND OF THE INVENTION

1. Field of the Invention

This invention relates to methodology for utilizing continual sensor-based data to design and adjust pressure-suits to fit an individual, in a given dynamic environment, preferably in an optimal manner.

2. Introduction to the Invention

Static fitting techniques to design and construct pressure-suits for specific people are known. A plaster cast is taken and an pressure-suit is produced based on that plastic impression. We note, however, that no attention is given to the dynamic workings of the body in the changing real environment. Specifically, the stresses and accelerations experienced by the body during normal operation are not taken into account, nor is an optimum balance, between support and comfort, taken into account.

### SUMMARY OF THE INVENTION

We have now discovered novel methodology for exploiting advantages inherent generally in sensing the dynamic workings (stresses) on specific bodies in actual motion, and using this sensor-based data to improve or optimize the design and construction of the desired pressure-suits.

Our work proceeds in the following way.

We have recognized that a typical and important paradigm for presently effecting pressure-suits construction, is a largely static and subjective human paradigm, and therefore exposed to all the vagaries and deficiencies otherwise attendant on static and human procedures. In sharp contrast, the novel paradigm we have in mind works in the following way.

First, a client wears a set of pressure and accelerations sensors mounted, say, inside a body-encasing device (suit). These sensors record their associated stresses and accelerations produced in normal individual motion in its dynamic environment for a prescribed period of time, preferably sufficient to capture all possible stress and acceleration patterns.

The dynamically acquired data are fed into a computer which creates a map of the forces and accelerations experienced by the examined body. This information may be used to design a preferably optimal pressure-suit which preferably maximizes support and minimizes discomfort, and can result in a computer production of a virtual pressure-suits that offers preferably optimal performance to the examined body in its normal operation. A physical pressure-suit can then be produced from a model provided by the virtual pressure-suit. This physical pressure-suit preferably provides maximum support and maximal comfort to its wearer, following the optimal design of the pressure-suit.

Accordingly, we now disclose a novel computer method which can preserve the advantages inherent in the static approach, while minimizing the incompleteness and attendant static nature and subjectivities that otherwise inure in techniques heretofore used.

To this end, in a first aspect of the present invention, we disclose a novel computer method comprising the steps of:

i) mounting pressure and acceleration sensors in a body-enclosing device;

ii) transmitting data produced by said sensors during actual operation of said body-enclosing device worn by a specific individual; and

iii) creating a stress-and-acceleration map based on said sensor-based data.

Preferably, the method includes a step for creating a virtual pressure-suit (model) for optimal support and comfort based on the stress-and-acceleration map; and, preferably includes a further step of constructing a physical pressure-suit based on a design provided by the virtual pressure-suit.

### BRIEF DESCRIPTION OF THE DRAWING

The invention is illustrated in the accompanying drawing, in which:

FIG. 1 provides an illustrative flowchart comprehending overall realization of the method of the present invention.

### DETAILED DESCRIPTION OF THE PRESENT INVENTION

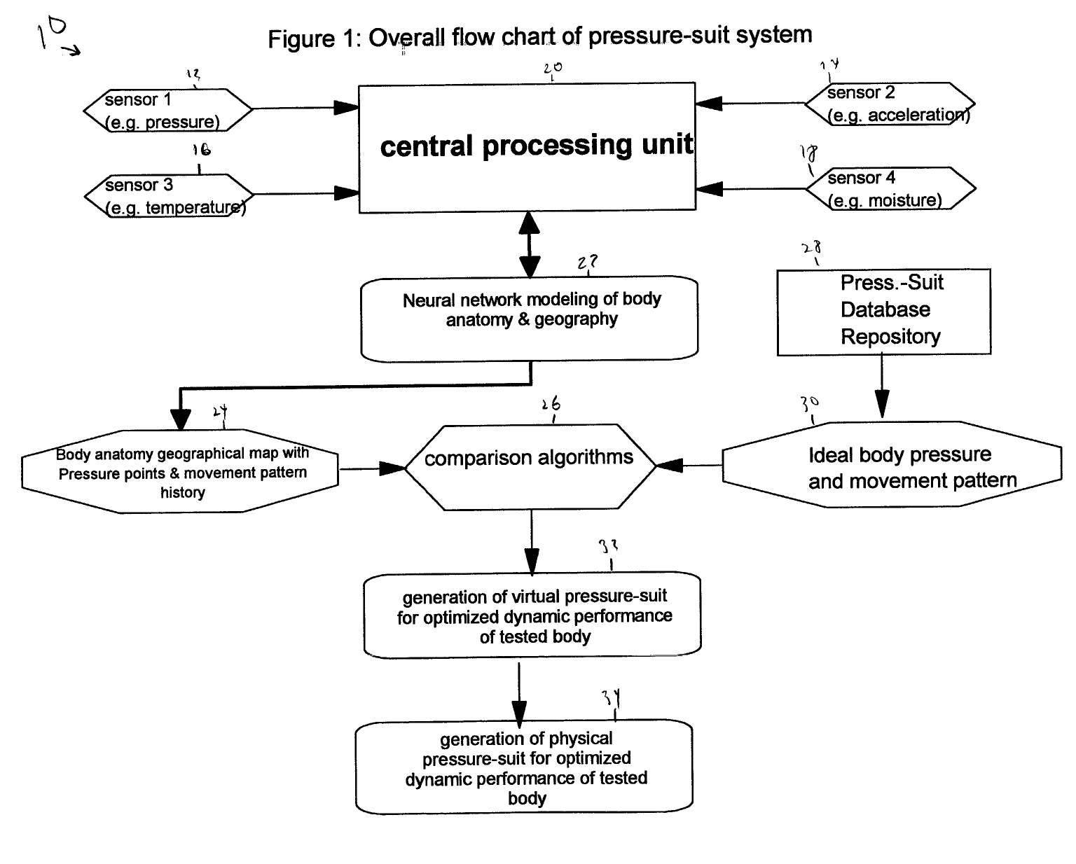

Attention is now directed to FIG. 1, which provides an overview flowchart (numerals 10-34) for typical and illustrative realization of the present invention.

In a typical case, a client's body may be fitted with a temporary suit comprising a number of sensors (12, 14, 16, 18), located at prescribed locations on the tested body. These sensors may include conventional pressure, acceleration, temperature, and/or humidity capabilities, and are preferably connected to a conventional recording device.

The client is asked to wear the suit for several operational days and follow his/her normal routine. During the test period, sensor data are recorded (including time stamps) in the recording device. The client returns the suit and the recording device at the end of the test period. The information stored in the recording device is then downloaded to a computer (20), which can store all data in a database.

The data are then analyzed by a program (preferably a neural network modeling program (22)), which can create maps of the tested body at different times. These maps also contain the sensors' reading at these times. Thus, this system now has information on the dynamic behavior of the tested body, including parametric information.

Based on these maps, and maps of an ideal body under similar conditions, an optimization program (32) designs an optimized virtual pressure-suit for the client. This design is then fed to a machine (34) which can generate an optimized physical pressure-suit.

What is claimed:

1. A computer method comprising the steps of:
i) mounting pressure and acceleration sensors in a body-enclosing device;
ii) transmitting data produced by said sensors during actual operation of said body-enclosing device worn by a specific individual for subsequent analysis by a computer; and
iii) creating a stress-and-acceleration map based on said sensor-based data.

2. A computer method according to claim 1, comprising a step of creating a virtual pressure-suit (model) for support and comfort based on the stress-and-acceleration map.

3. A computer method according to claim 2, comprising a step of constructing a physical pressure-suit based on a design provided by the virtual pressure-suit.

4. A method according to claim 1, comprising a step of using a sensor selected from the group consisting of temperature, moisture, and skin conductivity, so that sensor output may be correlated with support and comfort of a worn pressure-suit.

5. A method according to claim 2, comprising a step of using an interpolation technique to completely map stresses and accelerations experienced by a body over a period of time.

6. A method according to claim 5, comprising a step of updating the virtual pressure-suit model by using the interpolating map.

7. A method according to claim 6, comprising a step of using the interpolated map to directly design the virtual pressure-suit in an optimal manner.

8. A method according to claim 1, comprising a step of using a linear technique to model an pressure-suit.

9. A method as in claim 8, comprising a step of employing neural networks as the modeling technique.

10. A method according the claim 5, comprising a step of employing regression as the modeling technique.

11. A method according to claim 8, comprising a step of employing expert systems as the modeling technique.

12. A program storage device readable by machine, tangibly embodying a program of instructions executable by the machine to perform method steps for fitting pressure-suits to individuals, the method comprising the steps of:
i) mounting pressure and acceleration sensors in a body-enclosing device;
ii) transmitting data produced by said sensors during actual operation of said body-enclosing device worn by a specific individual for subsequent analysis by a computer; and
iii) creating a stress-and-acceleration map based on said sensor-based data.
